(19) United States
(12) Patent Application Publication
(10) Pub. No.: US 2011/0285969 A1
(43) Pub. Date: Nov. 24, 2011

(54) MICRO PROJECTION DEVICE FOR SIMPLIFYING OPTICAL COMPONENT AND INCREASING LIGHT-GUIDING PRECISION

(76) Inventor: Liu-Liang Liao, Taichung City (TW)

(21) Appl. No.: 12/781,931

(22) Filed: May 18, 2010

(51) Int. Cl. G03B 21/16; G03B 21/28

(52) U.S. Cl. 353/33; 353/37

(57) ABSTRACT

A micro projection device includes a light-emitting unit, a first lens unit, a reflective unit, a second lens unit, a prism unit, an image display unit and a projection unit. The light-emitting unit has three light-emitting modules. Each light-emitting module has a heat-dissipating element, a light-emitting element and a light-guiding element combined with the heat-dissipating element for receiving light beams generated by the light-emitting element. The first lens unit has three first lens sets respectively disposed beside the three light-emitting modules. The reflective unit is disposed beside the first lens unit. The second lens unit is disposed beside the reflective unit. The prism unit is disposed beside the second lens unit. The image display unit has a reflective image display panel disposed beside one side of the prism unit. The projection unit has a projection lens disposed beside another side of the prism unit.

### BACKGROUND OF THE INVENTION

1. Field of the Invention

The present invention relates to a micro projection device, and more particularly, to a micro projection device for simplifying optical component and increasing light-guiding precision.

2. Description of Related Art

Due to the development of optical and projection display technology, digital projection devices with a high number of dots per inch and pixels are often used for briefings, meetings, conferences or trainings. They have also become an important apparatus for family entertainment. Such potential consumers look for a lightweight digital projection apparatuses with high image quality and brightness, all at, of course, a reasonable price.

A projector is an apparatus for projecting images onto a large size screen by optical projection. A projector can be substantially classified into four types, CRT projector, liquid crystal display (LCD) projector, digital light processing (DLP) projector, and liquid crystal on silicon (LCOS) projector, depending on which light valve is adopted. The LCD projector is a transmission projector for its perviousness to light, and LCOS, DLP projectors are reflection projectors because they form images relying on light reflection.

The LCOS projector and the LCD projector are based on similar principles, but the LCOS projector modulates light signals emitted from a light source to a screen by an LCOS panel. In fabricating the LCOS panel, CMOS wafer is adopted as a circuit substrate and a reflection layer. Following that, a liquid crystal layer is coated and packed with a glass panel. Since a reflection structure is adopted in the LCOS projector, light signals emitted from the light source do not pass through the LCOS panel. As a result, the LCOS projector is a reflection projector. On the contrary, in an LCD projector, the light source is mounted behind the LCD panel, and light signals pass through the LCD panel. Therefore, the LCD projector is a transmission projector.

However, in the prior art, the optical components assembled in traditional projector are complex no matter whether the LCD panel or the LCOS panel is adopted. Hence, the optical path and the size of the traditional projector can not be effectively reduced. Besides, the traditional projector uses a single light pipe to integrate optical path, so that the optical path tolerance of the traditional projector is increased.

### SUMMARY OF THE INVENTION

One particular aspect of the present invention is to provide a micro projection device for simplifying optical component and increasing light-guiding precision, so that the questions of using complex optical components to increase the size and using the single light pipe to generate large optical path tolerance in the prior art can be effectively solved by the micro projection device in the present invention.

In order to achieve the above-mentioned aspects, the present invention provides a micro projection device for simplifying optical component and increasing light-guiding precision, including: a light-emitting unit, a first lens unit, a reflective unit, a second lens unit, a prism unit, an image display unit and a projection unit. The light-emitting unit has at least three light-emitting modules. Each light-emitting module has at least one heat-dissipating element, at least one light-emitting element disposed on the at least one heat-dissipating element and at least one light-guiding element combined with the at least one heat-dissipating element for receiving light beams generated by the at least one light-emitting element. The first lens unit has at least three first lens sets, and the three first lens sets are respectively disposed beside sides of the at least three light-emitting modules. The reflective unit is disposed beside one side of the first lens unit. The second lens unit is disposed beside one side of the reflective unit. The prism unit is disposed beside one side of the second lens unit. The image display unit has at least one reflective image display panel disposed beside one side of the prism unit. The projection unit has at least one projection lens disposed beside another side of the prism unit.

In order to achieve the above-mentioned aspects, the present invention provides a micro projection device for simplifying optical component and increasing light-guiding precision, including: a light-emitting unit, a first lens unit, a reflective unit, a second lens unit, a prism unit, an image display unit and a projection unit. The light-emitting unit has at least three light-emitting modules. Each light-emitting module has at least one heat-dissipating element, at least one light-emitting element disposed on the at least one heat-dissipating element and at least one light-guiding element combined with the at least one light-emitting element for receiving light beams generated by the at least one light-emitting element. The first lens unit has at least three first lens sets, and the three first lens sets are respectively disposed beside sides of the at least three light-emitting modules. The reflective unit is disposed beside one side of the first lens unit. The second lens unit is disposed beside one side of the reflective unit. The prism unit is disposed beside one side of the second lens unit. The image display unit has at least one reflective image display panel disposed beside one side of the prism unit. The projection unit has at least one projection lens disposed beside another side of the prism unit.

Therefore, because the at least one light-guiding element alternatively combines with the at least one heat-dissipating element or the at least one light-emitting element for receiving light beams generated by the at least one light-emitting element, each single light-guiding element can mate with each single heat-dissipating element or each single light-emitting element in order to simplify optical component, shorten optical path, decrease optical path tolerance, increase light-guiding precision and so on.

In order to further understand the techniques, means and effects the present invention takes for achieving the prescribed objectives, the following detailed descriptions and appended drawings are hereby referred, such that, through which, the purposes, features and aspects of the present invention can be thoroughly and concretely appreciated; however, the appended drawings are provided solely for reference and illustration, without any intention that they be used for limiting the present invention.

### BRIEF DESCRIPTION OF THE DRAWINGS

FIG. 1 is a schematic view of the micro projection device according to the first embodiment of the present invention;

FIG. 2 is a schematic view of the micro projection device according to the second embodiment of the present invention;

FIG. 3 is a partial, schematic view of the micro projection device according to the third embodiment of the present invention; and

FIG. 4 is a schematic view of the light-emitting unit of the micro projection device according to the fourth embodiment of the present invention.

### DETAILED DESCRIPTION OF THE PREFERRED EMBODIMENTS

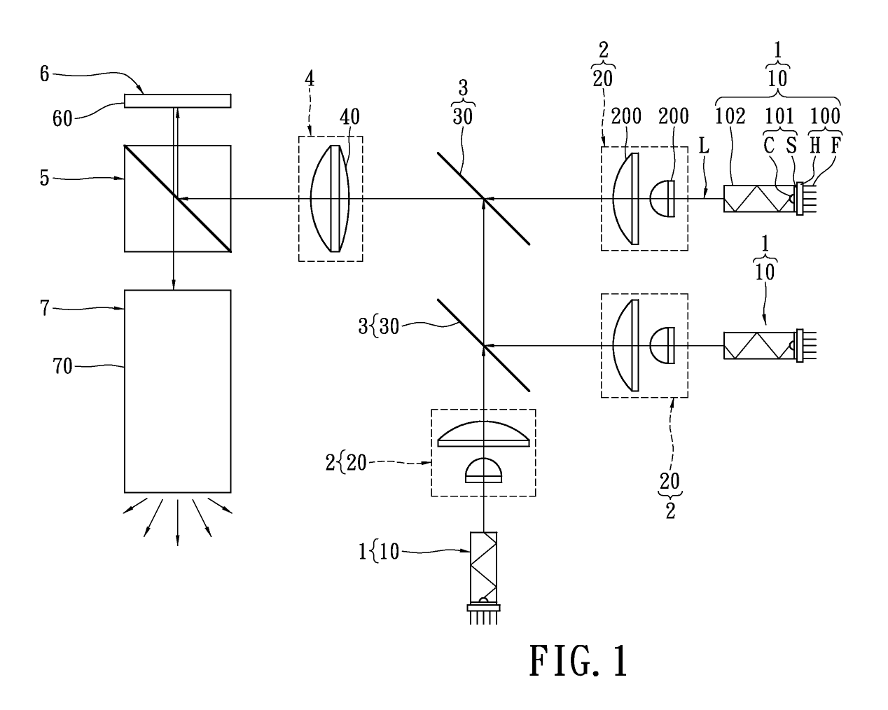

Referring to FIG. 1, the first embodiment of the present invention provides a micro projection device for simplifying optical component and increasing light-guiding precision, including: a light-emitting unit 1, a first lens unit 2, a reflective unit 3, a second lens unit 4, a prism unit 5, an image display unit 6 and a projection unit 7.

The light-emitting unit 1 has at least three light-emitting modules 10. Each light-emitting module 10 has at least one heat-dissipating element 100, at least one light-emitting element 101 disposed on the at least one heat-dissipating element 100 and at least one light-guiding element 102 combined with the at least one heat-dissipating element 100 for receiving light beams L generated by the at least one light-emitting element 101.

For example, the at least three light-emitting elements 101 are a red LED, a green LED and a blue LED, respectively. Hence, the light-emitting unit 1 can generate red, green and blue light at the same time. In addition, each heat-dissipating element 100 has a heat-dissipating substrate H and a plurality of heat-dissipating fins F extended downwards from a bottom side of the heat-dissipating substrate H. Each light-emitting element 101 has a circuit substrate S and an LED chip C disposed on and electrically connected to the circuit substrate S. The LED chips C may be a red LED chip, a green LED chip and a blue LED chip. Moreover, each light-guiding element 102 has an end portion contacting a top surface of each heat-dissipating element 100 and covering each light-emitting element 101. In other words, each light-guiding element 102 and each heat-dissipating element 100 are combined together to form a single piece component in order to decrease optical path tolerance and increase light-guiding precision.

Furthermore, the first lens unit 2 has at least three first lens sets 20, and the three first lens sets 20 are respectively disposed beside sides of the at least three light-emitting modules 10. For example, each first lens set 20 has at least two lenses 200 mated with each other for receiving the light beams L that are projected from each light-guiding element 102.

Besides, the reflective unit 3 is disposed beside one side of the first lens unit 2. For example, the reflective unit 3 has at least two reflective elements 30, one of the at least two reflective elements 30 is disposed beside one side of one of the at least three first lens sets 20, and other reflective element 30 is disposed between other two first lens sets 20 that share the other reflective element 30.

In addition, the second lens unit 4 is disposed beside one side of the reflective unit 3. For example, the second lens unit 4 has at least one second lens set 40 disposed between one reflective element 30 of the reflective unit 3 and the prism unit 5.

Moreover, the prism unit 5 is disposed beside one side of the second lens unit 4. The image display unit 6 has at least one reflective image display panel 60 disposed beside one side of the prism unit 5 and the projection unit 7 has at least one projection lens 70 disposed beside another side of the prism unit 5, so that the reflective image display panel 60 and the projection lens 70 are respectively disposed beside two opposite sides of the prism unit 5. For example, the prism unit 5 may be a polarizing beam splitting element, and the at least one reflective image display panel 60 may be an LCOS panel.

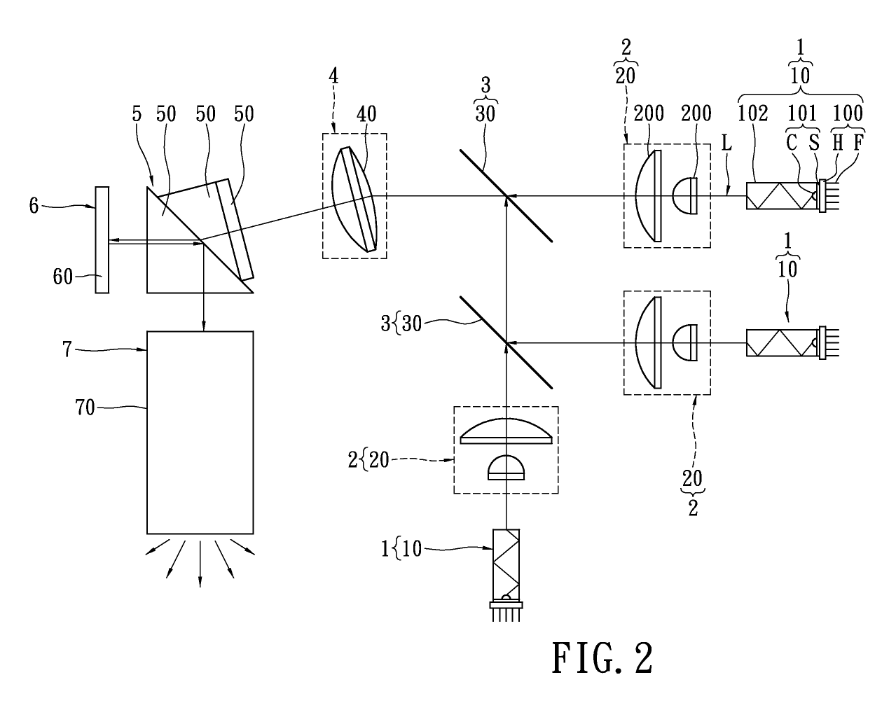

Referring to FIG. 2, the second embodiment of the present invention provides a micro projection device for simplifying optical component and increasing light-guiding precision, including: a light-emitting unit 1, a first lens unit 2, a reflective unit 3, a second lens unit 4, a prism unit 5, an image display unit 6 and a projection unit 7. The difference between the second embodiment and the first embodiment is that: in the second embodiment, the prism unit 5 may be a prism set that is composed of a plurality of prisms 50, and the at least one reflective image display panel 60 may be a DLP panel.

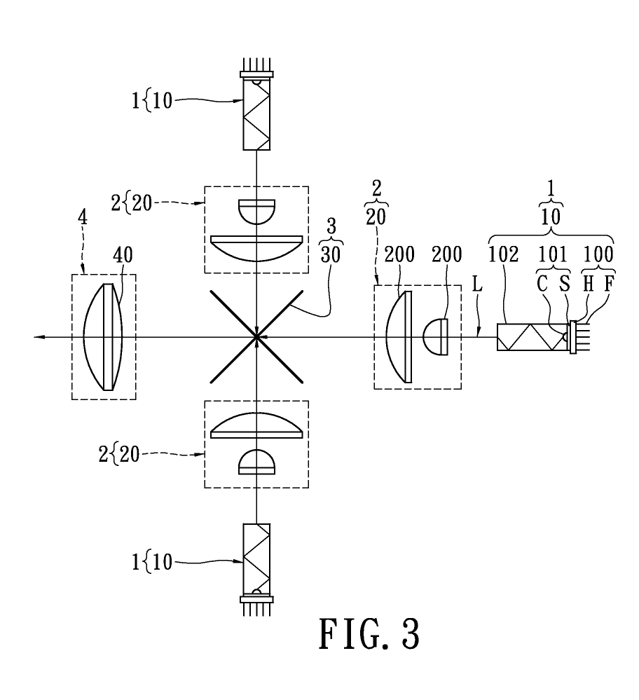

Referring to FIG. 3, the third embodiment of the present invention provides a micro projection device for simplifying optical component and increasing light-guiding precision. In the third embodiment, the reflective unit 3 has at least one reflective element 30 disposed between the at least three first lens sets 20, and the at least three first lens sets 20 share the at least one reflective element 30.

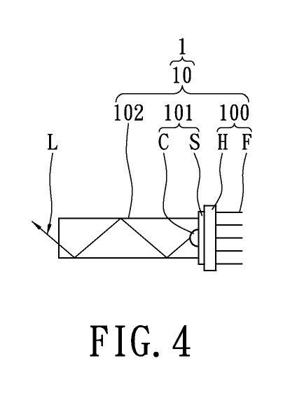

FIG. 4 shows a schematic view of the light-emitting unit according to the fourth embodiment of the present invention. Each light-emitting module 10 has at least one heat-dissipating element 100, at least one light-emitting element 101 disposed on the at least one heat-dissipating element 100 and at least one light-guiding element 102 combined with the at least one light-emitting element 101 for receiving light beams L generated by the at least one light-emitting element 101. In addition, each light-guiding element 102 has an end portion contacting a top surface of the circuit substrate S of each light-emitting element 101 and covering each light-emitting element 101. In other words, each light-guiding element 102 and each light-emitting element 101 are combined together to form a single piece component in order to decrease optical path tolerance and increase light-guiding precision.

In conclusion, because the at least one light-guiding element alternatively combines with the at least one heat-dissipating element or the at least one light-emitting element for receiving light beams generated by the at least one light-emitting element, each single light-guiding element can mate with each single heat-dissipating element or each single light-emitting element in order to simplify optical component, shorten optical path, decrease optical path tolerance, increase light-guiding precision and so on.

The above-mentioned descriptions merely represent solely the preferred embodiments of the present invention, without any intention or ability to limit the scope of the present invention which is fully described only within the following claims. Various equivalent changes, alterations or modifications based on the claims of present invention are all, consequently, viewed as being embraced by the scope of the present invention.

What is claimed is:

1. A micro projection device for simplifying optical component and increasing light-guiding precision, comprising:
a light-emitting unit having at least three light-emitting modules, wherein each light-emitting module has at least one heat-dissipating element, at least one light-emitting element disposed on the at least one heat-dissipating element and at least one light-guiding element combined with the at least one heat-dissipating element for receiving light beams generated by the at least one light-emitting element;
a first lens unit having at least three first lens sets respectively disposed beside sides of the at least three light-emitting modules;
a reflective unit disposed beside one side of the first lens unit;
a second lens unit disposed beside one side of the reflective unit;
a prism unit disposed beside one side of the second lens unit;
an image display unit having at least one reflective image display panel disposed beside one side of the prism unit; and
a projection unit having at least one projection lens disposed beside another side of the prism unit.

2. The micro projection device as claimed in claim 1, wherein the at least three light-emitting elements are a red LED, a green LED and a blue LED, respectively.

3. The micro projection device as claimed in claim 1, wherein each light-emitting element has a circuit substrate and an LED chip disposed on and electrically connected to the circuit substrate.

4. The micro projection device as claimed in claim 1, wherein each heat-dissipating element has a heat-dissipating substrate and a plurality of heat-dissipating fins extended downwards from a bottom side of the heat-dissipating substrate.

5. The micro projection device as claimed in claim 1, wherein each light-guiding element has an end portion contacting a top surface of each heat-dissipating element and covering each light-emitting element.

6. The micro projection device as claimed in claim 1, wherein the reflective unit has at least two reflective elements, one of the at least two reflective elements is disposed beside one side of one of the at least three first lens sets, and other reflective element is disposed between other two first lens sets that share the other reflective element.

7. The micro projection device as claimed in claim 1, wherein the reflective unit has at least one reflective element disposed between the at least three first lens sets, and the at least three first lens sets share the at least one reflective element.

8. The micro projection device as claimed in claim 1, wherein the second lens unit has at least one second lens set disposed between the reflective unit and the prism unit.

9. The micro projection device as claimed in claim 1, wherein the prism unit is a polarizing beam splitting element, and the at least one reflective image display panel is an LCOS panel.

10. The micro projection device as claimed in claim 1, wherein the prism unit is a prism set composed of a plurality of prisms, and the at least one reflective image display panel is a DLP panel.

11. A micro projection device for simplifying optical component and increasing light-guiding precision, comprising:
a light-emitting unit having at least three light-emitting modules, wherein each light-emitting module has at least one heat-dissipating element, at least one light-emitting element disposed on the at least one heat-dissipating element and at least one light-guiding element combined with the at least one light-emitting element for receiving light beams generated by the at least one light-emitting element;
a first lens unit having at least three first lens sets respectively disposed beside sides of the at least three light-emitting modules;
a reflective unit disposed beside one side of the first lens unit;
a second lens unit disposed beside one side of the reflective unit;
a prism unit disposed beside one side of the second lens unit;
an image display unit having at least one reflective image display panel disposed beside one side of the prism unit; and
a projection unit having at least one projection lens disposed beside another side of the prism unit.

12. The micro projection device as claimed in claim 11, wherein the at least three light-emitting elements are a red LED, a green LED and a blue LED, respectively.

13. The micro projection device as claimed in claim 11, wherein each light-emitting element has a circuit substrate and an LED chip disposed on and electrically connected to the circuit substrate.

14. The micro projection device as claimed in claim 13, wherein each light-guiding element has an end portion contacting a top surface of the circuit substrate of each light-emitting element and covering each light-emitting element.

15. The micro projection device as claimed in claim 11, wherein each heat-dissipating element has a heat-dissipating substrate and a plurality of heat-dissipating fins extended downwards from a bottom side of the heat-dissipating substrate.

16. The micro projection device as claimed in claim 11, wherein the reflective unit has at least two reflective elements, one of the at least two reflective elements is disposed beside one side of one of the at least three first lens sets, and other reflective element is disposed between other two first lens sets that share the other reflective element.

17. The micro projection device as claimed in claim 11, wherein the reflective unit has at least one reflective element disposed between the at least three first lens sets, and the at least three first lens sets share the at least one reflective element.

18. The micro projection device as claimed in claim 11, wherein the second lens unit has at least one second lens set disposed between the reflective unit and the prism unit.

19. The micro projection device as claimed in claim 11, wherein the prism unit is a polarizing beam splitting element, and the at least one reflective image display panel is an LCOS panel.

20. The micro projection device as claimed in claim 11, wherein the prism unit is a prism set composed of a plurality of prisms, and the at least one reflective image display panel is a DLP panel.
